(19) United States
(12) Patent Application Publication
(10) Pub. No.: US 2008/0243708 A1
(43) Pub. Date: Oct. 2, 2008

(54) Business fund raising through insurance underwriting

(76) Inventor: Tony Unwin, Orlando, FL (US)

Correspondence Address: FURR LAW FIRM, 2622 DEBOLT ROAD, UTICA, OH, 43080, US

(21) Appl. No.: 11/692,181

(22) Filed: Mar. 27, 2007

(51) Int. Cl. G06Q 40/00

(52) U.S. Cl. 705/36 R

(57) ABSTRACT

The current invention is a system, method and program product that uses assets held by Businesss—i.e. land, mineral rights, etc. to underwrite insurance and generate revenues. The Business pledges assets it does not use and produce no income. The Business retains the right to use the assets. The Business receives 5-15% of the asset value per year in underwriting income. The Business re-insures to prevent the possibility of any loss.

### CROSS-REFERENCES TO RELATED APPLICATIONS (IF ANY)

None

### STATEMENT AS TO RIGHTS TO INVENTIONS MADE UNDER FEDERALLY-SPONSORED RESEARCH AND DEVELOPMENT (IF ANY)

None

### BACKGROUND OF INVENTION

1. Field of the Invention

The present invention is directed to a method of business fund raising, more particular raising funds through insurance underwriting.

2. Background

Insurance company underwriting is backed by assets. Often the insurance company does not own these assets, but rather has these pledged to it. The assets are often pledged by companies or wealthy individuals. The pledger typically receives 5-15% return per annum on the value of the pledged assets and has the additional benefit of not having to sell the assets.

This is especially useful with items such as artwork, land, precious metals, that often do not produce an income, can be made to do so and still be retained by the owner. Risks to the owner of insurance loss are mitigated by an in depth knowledge of the likelihood of payouts by the insurance company. Insurance companies are not in the business of paying claims. They make money by taking in premiums and paying little or nothing out.

Insurance risk can also be re-insured, i.e. the risk split between many different parties. It is also possible to buy insurance against the risk of loss—i.e. insurance against needing to meet a claim.

English aristocrats are in an unusual situation—they have large asset holdings, yet little income. They are loaded with liquidate assets, yet need money to live. Many of them solve this dilemma by becoming Lloyds “names”. These are wealthy individual and corporate underwriters of insurance on the Lloyds of London market. They pledge their assets and receive underwriting premiums of 5-15% of the asset's value each year in underwriting revenue.

Many business entities are in a very similar situation—having large amounts of assets yet little income other than taxation. As outlined in this current invention, by pledging these assets they could create a new source of revenue that does not currently exist.

3. Prior Art

U.S. Pat. No. 6,847,946 by Blanz, et al. and issued on Jan. 25, 2005 discloses a Multi-note method and system for loans based upon lease revenue stream. It is a method, system and program product for creating a loan from a revenue stream from a lessee, the method comprising the steps of: determining a revenue stream from a lease of a leased tangible asset; calculating a Breakeven TA Note Rate, and a TA Note Amount for a TA Note based on a Multi-Note Loan Coupon, a TA Note Debt Service and market determined underwriting parameters for the tangible asset; calculating an CL Note Debt Service after the TA Note debt service, and other appropriate amounts, if necessary are subtracted from the revenue; calculating a Breakeven CL Note Rate and a CL Note Amount for a CL Note based on the calculated CL Note Debt Service, the Multi-Note Loan Coupon, a CL Note Debt Service, and market determined underwriting parameters; creating a file structure of one or more files for the TA Note and the CL Note; and associating the TA Note and CL Note to assign priorities for purposes of determining and distributing recoveries to holders of the TA Note and/or the CL Note and/or their designees in the event of a Multi-Note Loan default and allocating the rights and responsibilities of the holders of such notes. In a preferred embodiment, the Multi-Note Loan Coupon is initially an estimated value.

While this enables the creation of a loan from a revenue stream. The current invention does not rely on a revenue stream and specifically avoids the need for a loan as funds received are underwriting revenue and do not have to be repaid. There is still room for improvement in the art.

### SUMMARY OF THE INVENTION

The current invention is a system, method and program product that uses assets held by Businesses—i.e. land, mineral rights, etc. to underwrite insurance and generate revenues. The Business pledges assets it does not use and produce no income. The Business retains the right to use the assets. The Business receives 5-15% of the asset value per year in underwriting income. The Business re-insures to prevent the possibility of any loss.

Given the significant value of the Businesses hold the monies involved are substantial.

### BRIEF DESCRIPTION OF THE DRAWINGS

Without restricting the full scope of this invention, the preferred form of this invention is illustrated in the following drawings:

FIG. 1 is a schematic block diagram of a conceptualized operation of the present invention; and

FIG. 2 is a block diagram showing a basic arrangement of a computer system that can run the current invention.

### BRIEF DESCRIPTION OF THE PREFERRED EMBODIMENTS

There are a number of significant design features and improvements incorporated within the invention.

The current invention is a system 1, method and program product that uses assets held by Businesses—i.e. land, mineral rights, etc. to underwrite insurance and generate revenues. The Business pledges assets it does not use and produce no income. The Business retains the right to use the assets. The Business receives 5-15% of the asset value per year in underwriting income. The Business re-insures to prevent the possibility of any loss. Given the significant value of Business holdings the monies involved are substantial.

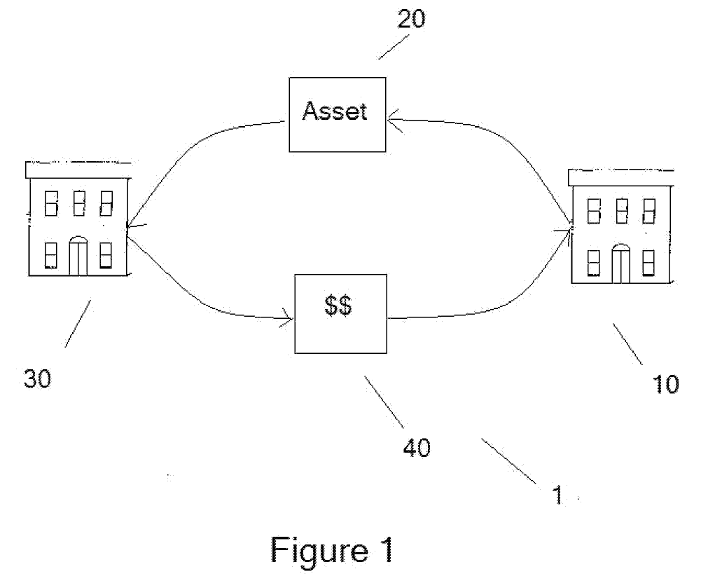

This system is shown in FIG. 1, the Business Entity 10, which can be any type of Business such as a corporation, LLC, limited partnership, etc., pledges its assets 20 to an insurance company 30 to underwrite insurance. The insurance company 30 will provide the Business 10 with underwriting income 40.

An example of the system is as follows. The Business holds title to a parcel of land. The Business offers to pledge the land for the generation of insurance revenues. The land is valued at $100M. A US insurance company accepts the pledge of the land. The company generates between $5M and $15M per annum in insurance revenue for the Business.

The Business 30 can select the types of risks it wishes to underwrite by picking syndicates to underwrite. The Business 30 can mitigate risk by picking low risk syndicates, re-insuring their underwriting, purchasing stop loss policies, insuring against the possibility of a payout, or a combination of these methods.

The current invention is an entirely new method of fundraising for Businesses. The revenue received do not have to be paid back which reduces Business reliance on taxation, borrowing and inflation as a means to raise capital. Given the size of Business asset holdings the potential income is significant. The extra “new” money created could finance new works or programs and reduce or eliminate the need for new or existing taxes.

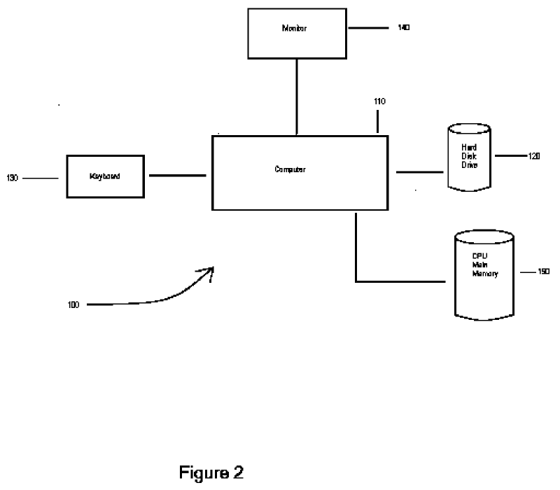

The system 1 can be set up to be run a on a computing device. FIG. 2 is a block diagram showing a computing device 100 on which the present invention can run comprising a CPU 110, Hard Disk Drive 120, Keyboard 130, Monitor 140, CPU Main Memory 150 and a portion of main memory where the program resides and executes. A printer can also be included. Any general purpose computer with an appropriate amount of storage space is suitable for this purpose. Computer Devices like this are well known in the art and is not pertinent to the invention.

The computer device 100 could be connected to other computer devices 100 through a communication interface such as the Internet, a wide area network (WAN), internetwork, telephone network or a private Value Added Network (VAN).

The storage and databases for the system may be implemented by a single data base structure at an appropriate site, or by a distributed data base structure that is distributed across an intra or an Internet network.

The files and file components discussed herein may be paper files, but in a preferred embodiment comprise data structures with electronic data. The setting up of the files and file structure is commonly known in the art and is not disclosed here.

It should be appreciated that many other similar configurations are within the abilities of one skilled in the art and all of these configurations could be used with the method of the present invention. Furthermore, it should be recognized that the computer system and network disclosed herein can be programmed and configured by one skilled in the art in a variety of different manners to implement the method steps described further herein.

### ADVANTAGES

The advantages of this to Businesses are the revenues are new “found” money. There is no borrowing involved. The income is “earned” and does not have to be paid back. The income stream is passive and on-going. Monies received do not have to be paid back. Debt does not increase. Liquidity ratios are not adversely affected. This reduces business reliance on borrowing and selling shares as a means to raise capital. Given the size of many business asset holdings the potential income is significant.

As to a further discussion of the manner of usage and operation of the present invention, the same should be apparent from the above description. Accordingly, no further discussion relating to the manner of usage and operation will be provided. With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A method comprising the steps: having a Business entity pledge assets and receiving payment for said pledge.

2. The method as defined in claim 1, wherein said pledge is in the form of a pledge for underwriting.

3. The method as defined in claim 2, where said pledge is to an insurance company.

4. The method as defined in claim 1, where said payment is based on the value of the pledged assets.

5. The method as defined in claim 2, where said Business entity can mitigate its risk by picking low risk syndicates.

6. The method as defined in claim 2, where said Business entity can mitigate its risk by re-insuring their underwritings.

7. The method as defined in claim 2, where said Business entity can mitigate its risk by insuring against a payout.

8. The method as defined in claim 1, where said Business entity has the rights to use the pledged assets.

9. The method as defined in claim 1, where said assets are unused assets.

10. A system comprising: a Business entity pledging assets and receiving payment for said pledge, where said pledge is in the form of a pledge for underwriting where said payment is based on the value of the pledged assets.

11. The system as defined in claim 10, where said pledge is to an insurance company.

12. The system as defined in claim 11, where said Business entity can mitigate its risk by picking low risk syndicates.

13. The system as defined in claim 11, where said Business entity can mitigate its risk by re-insuring their underwritings.

14. The system as defined in claim 11, where said Business entity can mitigate its risk by insuring against a payout.

15. The system as defined in claim 10, where said system is running on a computer processing device.

16. The system as defined in claim 10, where said Business entity has the rights to use the pledged assets.

17. A method comprising the steps: having a Business entity pledge assets and receiving payment for said pledge, having said pledge is in the form of a pledge for underwriting, pledging said assets is to an insurance company, having said payment is based on the value of the pledged assets, having said Business entity having rights to use the pledged assets.

18. The method as defined in claim 17, where said Business entity can mitigate its risk by picking low risk syndicates.

19. The method as defined in claim 17, where said Business entity can mitigate its risk by re-insuring their underwritings.

20. The method as defined in claim 17, where said Business entity can mitigate its risk by insuring against a payout.
